(19) United States
(12) Patent Application Publication
(10) Pub. No.: US 2010/0223548 A1
(43) Pub. Date: Sep. 2, 2010

(54) METHOD FOR INTRODUCING INTERACTION PATTERN AND APPLICATION FUNCTIONALITIES

(75) Inventors: Thomas Portele, Bonn (DE); Holger Scholl, Herzogenrath (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/063,110

(22) PCT Filed: Aug. 1, 2006
(86) PCT No.: PCT/IB06/52628

§ 371 Date: Feb. 7, 2008

(30) Foreign Application Priority Data
Aug. 11, 2005 (EP) 05107397.1

(51) Int. Cl. G06F 3/048

(52) U.S. Cl. 715/705

(57) ABSTRACT

The invention describes a method for introducing interaction pattern and/or functionalities of a plurality of cations (11, 11′, 11″) to the user (13) of an interactive system (1). An application (11, 11′, 11″) provides characteristics (CR) of its interaction pattern and/or functionalities to the interactive system (1). The interactive system (1) then generates a selection (SE) of the interaction pattern and/or functionalities of an application (11, 11′, 11″) which are to be introduced to the user (13), and subsequently invokes the rendering of tutorial elements (6, 7, 14) to the user (13) to introduce the selected interaction pattern and/or functionalities. Moreover, the invention describes an appropriate interactive system (1) supporting the execution of a plurality of applications (11, 11′, 11″), which is providing introductions of interaction pattern and/or functionalities of the applications (11, 11′, 11″).

This invention relates to a method for introducing interaction pattern and/or functionalities of applications to the user of an interactive system, and to a corresponding interactive system.

In the recent years, the number of technical systems operated by a person on a regular basis has been increasing. Examples of such systems are mobile phones, navigation systems, laptop computers, car entertainment systems, or personal digital assistants (PDAs). Many of these technical systems are interactive systems, meaning that they are equipped with a user interface allowing the user to interact with the system in some form by providing input to the system as well as receiving outputs from the system. Common means for interacting with a technical system are stemming from desktop computers, having a keyboard and a mouse as input means and a computer screen as an output means. Often, users are familiar with typical tasks that can be performed with those means, for example using the mouse for dragging a computer file from one location and dropping it to a different location.

More advanced technical systems are offering additional styles of interacting with the user. For example, a system might comprise a microphone and a loudspeaker as well as speech processing units. In this case, the interactive system might be able to receive and process spoken input from a user and generate spoken output in response to the user's input. WO 03/096171 A1 discloses a device having means for picking up and recognizing speech signals as well as means for supplying speech signals.

Moreover, a system might be able to receive inputs in form of gestures picked up by a camera. The system can react to those inputs by providing gestures or certain facial expressions with means like robotic arms or mechanical implementations of a human face.

Obviously, it cannot be assumed that a user of an interactive system is familiar with all the interaction pattern and/or functionalities supported by an interactive system. An introduction of the interaction pattern and/or functionalities is needed to ensure that the user is able to use the applications of the interactive system efficiently. However, introductions in printed form are less desirable, since the user rarely accepts them.

Typically, interactive systems offer the flexibility of executing several applications providing different features. The set of applications might not be fixed from the beginning, applications can be added to the system during the lifetime of the system. For example, a car entertainment system might already contain a player application for MP3 audio files as well as a video player application. Later, a navigation system application might be added to the system. With every new application added to the interactive system, interaction pattern and/or functionalities not known to the user might become available. However, as the user has been using some of the applications of the interactive system already, he might be familiar with some of the interaction pattern. Consequently, introducing all interaction pattern of the newly added application is not desirable. In addition, some of the interaction pattern provided by the application might not be useful for a specific interactive system. For example, interaction pattern requiring speech input might not be applicable if the interactive system is installed in a noisy environment. Again, the introduction of all interaction pattern of an application will not be desirable.

It is therefore a general object of the invention to provide a method and an interactive system for introducing interaction pattern and/or functionalities of applications to the user of an interactive system while avoiding that the introductions are perceived as being inappropriate, inefficient, or boring.

To accomplish these objects, the present invention provides a method for introducing interaction pattern and/or functionalities of a plurality of applications to the user of an interactive system, wherein an application provides characteristics of its interaction pattern and/or functionalities to the interactive system. The interactive system generates a selection of interaction pattern and/or functionalities of an application, which are to be introduced to the user. Subsequently, according to the invention, the interactive system invokes the rendering of tutorial elements to the user to introduce the selected interaction pattern and/or functionalities.

An interactive system supporting the execution of a plurality of applications, which is providing introductions of interaction pattern and/or functionalities of the applications comprises a user interface, a registration unit, a selection unit, and a tutorial unit. The registration unit receives the characteristics of the interaction pattern and/or functionalities, which are provided by the applications. The selection unit selects which of the interaction pattern and/or functionalities are introduced to the user. Subsequently, the tutorial unit invokes the rendering of tutorial elements to the user to introduce the selected interaction pattern and/or functionalities.

Hereby, an “interaction pattern” refers to a specific style or method, which is used for exchanging information between the interactive system and the user of the interactive system. Such interaction pattern might for example be described in terms of the initiative (for example user-driven, system-driven, or mixed initiative), the input and output modality (for example speech, gesture, or keystrokes), or the confirmation strategy (for example immediate execution, double entry, or user confirmation required). According to those characteristics, a command “increase volume” spoken by the user, which is executed immediately by the system, is an example of a user-driven, speech-based interaction pattern not requiring a confirmation.

Since each application added to an interactive system has to provide the characteristics of its interaction pattern to the interactive system, the interactive system will be enabled to select which of the interaction pattern should be introduced to the user. Instead of allowing each application to introduce all interaction pattern when an application is added or executed for the first time, the interactive system advantageously avoids introductions of interaction pattern which are inappropriate, redundant, or otherwise useless, like for example speech modality interaction pattern in a noisy environment. Also, the interactive system may advantageously select introductions of interaction pattern depending on the characteristics of the user interface. If a user interface does not provide means for speech generation, the introduction of interaction pattern requiring speech generation will not be selected by the interactive system. Particularly, this selection might depend on the current state of the user interface. For example, interaction pattern requiring a display will not be introduced if the display is currently not usable.

Besides the interaction pattern, an application will also provide characteristics of its functionalities to the interactive system, hereby enabling the interactive system to select the functionalities that should be introduced to the user.

Preferably, the tutorial elements rendered to user will be provided via the user interface of the interactive system. For example, if the user interface comprises a screen, video recordings might be displayed on the screen to introduce a certain interaction pattern. Another example would be a tutorial element that is teaching the user to prefer a certain spoken command, like “increase volume” instead of “more volume” to raise the volume of an audio file player application.

The dependent claims disclose particularly advantageous embodiments and features of the invention whereby the system could be further developed according to the features of the method claims.

Preferably, the selection of the interaction pattern and/or functionalities is deduced from data of previous introductions of interaction pattern and/or functionalities. Here, the data might comprise records of all interaction pattern and/or functionalities that have been introduced already. Consequently, the interactive system will only select interaction pattern and/or functionalities that have not been introduced in the past. Thereby, the interactive system advantageously avoids redundant introductions. For example, the user of a car entertainment system is familiar with the interaction pattern to adjust the volume of a MP3 audio file player application. It would be redundant to introduce this interaction pattern again, when a navigation system application is added. Furthermore, the data might comprise dates indicating when an interaction pattern and/or functionality was introduced. If a date indicates, that an introduction was given a longer time ago, the system might select to introduce this interaction pattern again, even though it was introduced before. Alternatively, the interactive system might offer the user the option to select if he wants to repeat an introduction.

Particularly, in a preferred embodiment of the invention, the interactive system identifies the user of a system and deduces the selection from data of previous introductions of interaction pattern and/or functionalities invoked for the identified user. Thereby, an interactive system used by more than one person is enabled to provide introductions according to the specific experience of each user with interaction pattern and/or functionalities. For example, two persons use a car, and only one person has been using the MP3 audio file player application so far. If a navigation system application is added, according to the example above, the car entertainment system will only introduce the interaction pattern for adjusting the volume to the user who has not been using the MP3 player application before. To identify the user of an interactive system, several methods are known. For example, a user might identify himself by typing a user identification on a keyboard. Alternatively, the interactive system might be able to recognize a user by analysing characteristics of the user's voice, iris, fingerprint, or other biometric data, as well as by identifying personal items like a car key.

According to a further embodiment of the invention, the tutorial elements for introducing interaction pattern are stored in a memory means of the interactive system. Preferably, the interactive system provides tutorial elements for all interaction pattern supported by the interactive system. Therefore, an interaction pattern used by an application can be introduced to the user even if the application does not provide any tutorial elements for this interaction pattern. Moreover, since the introductions are all provided from the same source, they will be similar in style, possibly improving the efficiency of the introductions.

Preferably, the tutorial elements stored in a memory means of the interactive system are adjusted to the functionalities of an application. This means that the interactive system is using the characteristics of the functionalities provided by the application to adjust the tutorial elements so that they will appear application-specific to the user. For example, if the interaction pattern for adjusting the volume must be introduced, the interactive system might demonstrate it by increasing the volume of the navigation system application.

In a further preferred embodiment, the tutorial elements for introducing interaction pattern and/or functionalities are stored in a memory means of an application. The application will provide data to the interactive system enabling the interactive system to invoke the rendering of the tutorial elements. This data could for example comprise computer readable addresses or entry points of the tutorial elements as well as data about the interaction pattern and/or functionalities that are introduced by the tutorial elements. In this case, the interactive system will use an entry point to locate and invoke the rendering of a tutorial element for a selected interaction pattern or functionality.

The interactive system might invoke the rendering of tutorial elements in response to an application registering at the interactive system. For example, when an application is added to the interactive system and the user does not know a certain interaction pattern, the interactive system will immediately invoke the rendering of the tutorial elements for this interaction pattern. Alternatively, the rendering of the tutorial elements for an unknown interaction pattern will only be invoked if the execution of an application supporting this interaction pattern is triggered by the user of the interactive system.

According to a further embodiment of the invention, an application provides characteristics of its interaction pattern with reference to the definition of interaction pattern supported by the interactive system. Thereby, an application will not provide characteristics of interaction pattern that cannot be used within an interactive system, for example like the above-mentioned speech based interaction pattern within a noisy environment.

The method and interactive system according to the invention may be realised for any kind of interactive system. Preferably, the interactive system comprises a speech based dialog system including a speech synthesis unit and a speech recognition unit. Compared to other interactive systems exclusively relying on user inputs via a keyboard or a mouse, interactive systems supporting speech based dialogs are typically less familiar to many users. Furthermore, background noise or a user's preference for certain verbal expressions are sources of misinterpretations by the speech recognition unit. Therefore, for interactive systems including a speech based dialog system, it is essential to provide an efficient method for introducing appropriate interaction pattern.

An interactive system according to the present invention might perform some of the processing steps described above by implementing software modules or a computer program product. Such a computer program product might be directly loadable into the memory of a programmable interactive system. Some of the units or modules such as the selection unit, or the tutorial unit can thereby be realised in the form of computer program modules. Since any required software or algorithms might be encoded on a processor of a hardware device, an existing electronic device might easily be adapted to benefit from the features of the invention. Alternatively, the units or blocks (for processing user input and the output prompts in the manner described) can equally be realised using hardware modules.

Other objects and features of the present invention will become apparent from the following detailed descriptions considered in conjunction with the accompanying drawings. It is to be understood, however, that the drawings are designed solely for the purposes of illustration and not as a definition of the limits of the invention.

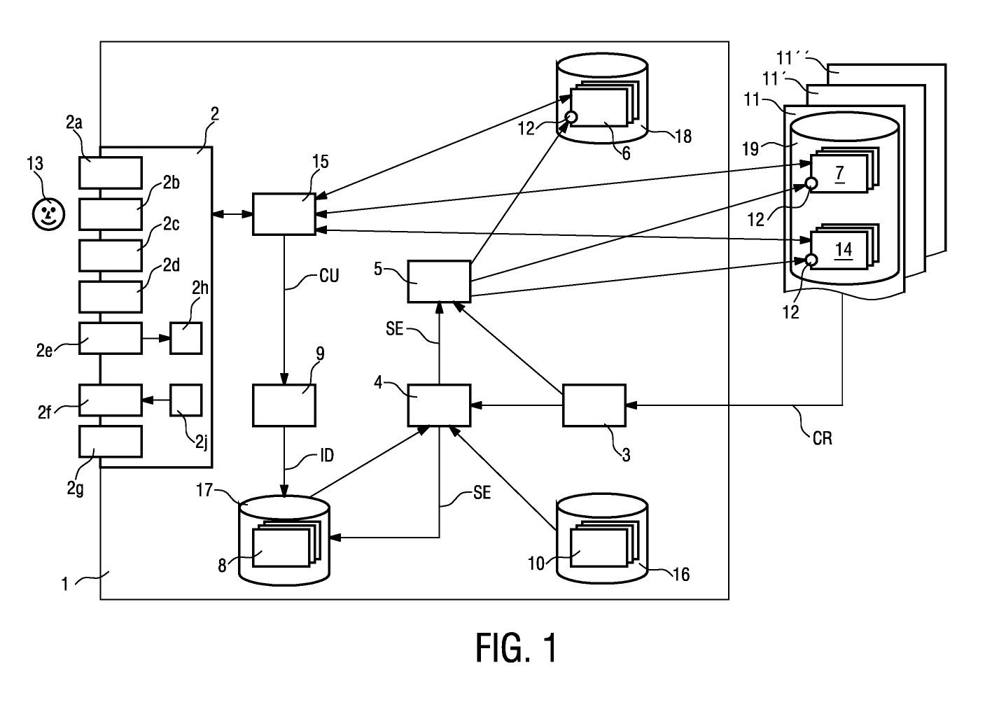

FIG. 1 is a schematic block diagram of an interactive system in accordance with an embodiment of the present invention;

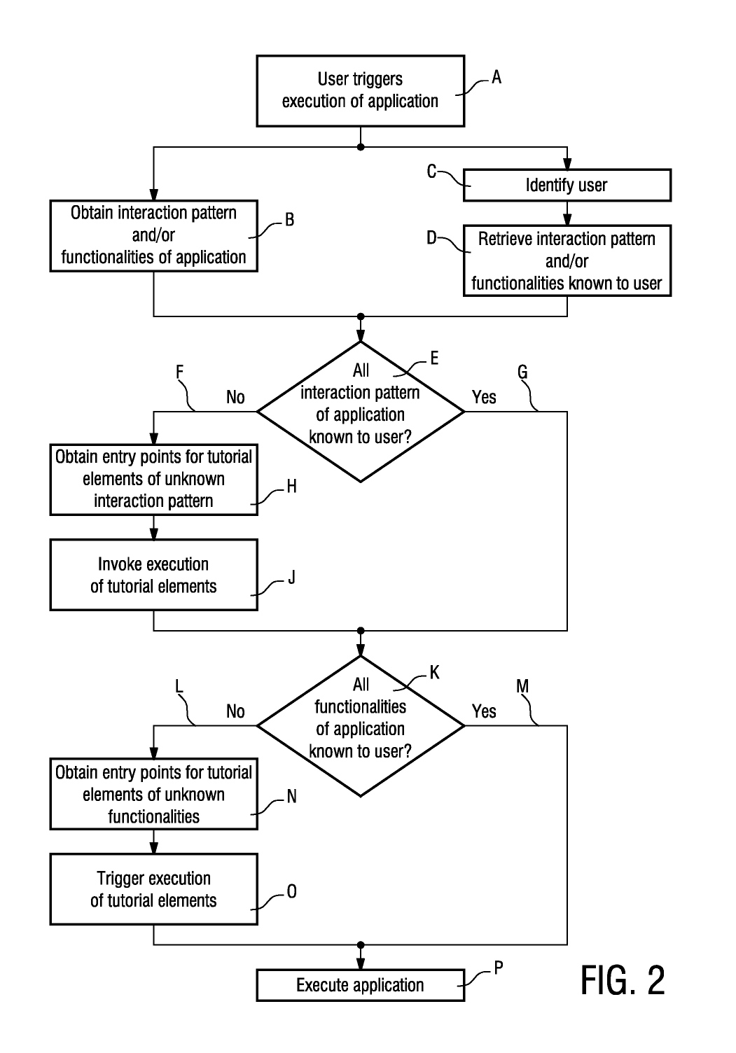

FIG. 2 is a flow chart illustrating a preferred embodiment of the sequence of operations for introducing interaction pattern and/or functionalities according to the invention.

FIG. 1 shows an interactive system 1 comprising units 2, 3, 4, 5, 9, 15, 16, 17, and 18. This interactive system 1 can be a system similar to that described in WO 03/096171 A1, which is incorporated here by reference. Furthermore, a user 13 as well as applications 11, 11′, 11″ are depicted.

An application 11, 11′, 11″ might comprise a storage unit 19 for storing a plurality of tutorial elements 7, 14. A first type of tutorial elements 7 is used to introduce interaction pattern, whereas another type of tutorial elements 14 features the introduction of functionalities. Each of the tutorial elements 7, 14 typically includes a computer-readable address or entry point 12, which enables the interactive system 1 to locate and invoke the rendering of the tutorial element.

Within the interactive system 1, a user interface 2 provides means such as a keyboard 2a, a joystick 2b, a mouse 2c, a camera 2d, and a microphone 2e to receive input data from the user 13. Furthermore, the user interface 2 includes means such as a loudspeaker 2f, and a display 2g for providing output data to user 13.

The dialog manager 15 receives and processes input data from the user interface 2 and provides the input data to other units within the applications 11, 11′, 11″ and the interactive system 1. In addition, the dialog manager 15 receives and processes inputs from the applications 11, 11′, 11″ and provides the input data to the user interface 2. A speech based dialog system for example would comprise, a microphone 2e that detects speech input of the user 13, and a speech recognition unit 2h that can comprise a usual speech recognition module and a following language understanding module, so that speech utterances of the user 13 can be converted into digital form. On the output side, the speech-based dialog system features a speech synthesis unit 2j, which can comprise, for example, a language generation unit and a speech synthesis unit. The synthesised speech is then output to the user 13 by means of a loudspeaker 2f. All of the components of the user interface 2 mentioned here, in particular the speech recognition unit 2h and the speech synthesis unit 2j, as well as the dialog manager 15 and the required interfaces (not shown in the diagram) between the dialog manager 15 and the individual applications 11, 11′, 11″ are known to a person skilled in the art and will not therefore be described in more detail.

Moreover, the dialog manager 15 provides characteristics CU of a user such as digitized data of the user's fingerprint to the user identification unit 9.

A storage unit 17 comprises records 8 of the interaction pattern and/or functionalities that have been introduced already. The user identification unit 9 identifies a user 13 and triggers the storage unit 17 to supply to the selection unit 4 the records 8 of the identified user ID. If a user 13 has not been using the interactive system 1 before, the storage unit 17 reports to the selection unit 4 that no records 8 are available, meaning that none of the interaction pattern and/or functionalities are known to the user 13.

The registration unit 3 serves as an interface to the applications 11, 11′, 11″. Each application 11, 11′, 11″ registering at the interactive system 1 provides characteristics CR of the interaction pattern and/or functionalities that are supported by the application 11, 11′, 11″ to the registration unit 3. This information is passed on to the selection unit 4. Furthermore, entry points 12 of the tutorial elements 7, 14 supplied by an application 11, 11′, 11″ to the registration unit 3 are passed on to the tutorial unit 5.

A storage unit 16 provides interaction pattern 10 that are supported by the interactive system 1 to the selection unit 4. In response to the inputs from the storage unit 17, the storage unit 16, and the registration unit 3, the selection unit 4 generates a selection of interaction pattern and/or functionalities that should be introduced to the current user 13 of the interactive system 1. Hereby, only those interaction pattern and/or functionalities are selected which are provided by the application 11, 11′, 11″ as indicated by the registration unit 3, supported by the interactive system 1 as indicated by the storage unit 16, and not known to the identified user ID as indicated by the storage unit 17.

This selection is passed (in form of appropriate selection data SE) on to the tutorial unit 5, which in response invokes the rendering of tutorial elements 6, 7, 14 to the user 13. The entry points 12 available inside the interactive system 1 or provided by the registration unit 3 are used to locate the tutorial elements 6 within the storage unit 18 of the interactive system 1 or to locate the tutorial elements 7, 14 within the storage unit 19 of the applications 11, 11′, 11″. A tutorial element 6, 7, 14 that has been invoked provides outputs to the user 13 via the dialog manager 15 and the user interface 2. Furthermore, the tutorial elements 6, 7, 14 might receive inputs from the user 13 via the user interface 2 and the dialog manager 15. For example, a tutorial element of the first type 7 that is used to teach the user 13 how to adjust the volume of the interactive system 1 might pick up a spoken command from the user 13 via the microphone 2e, the speech recognition unit 2h, and the dialog manager 15 and then confirms or rejects it by relaying a spoken response to the user 13 via the dialog manager 15, the speech synthesis unit 2j, and the loudspeaker 2f.

Moreover, the selection unit 4 reports the selection data SE concerning the interaction pattern and/or functionalities that have been selected for introduction back to the storage unit 17. Thereby, in the future, those interaction pattern and/or functionalities will be recognized by the storage unit 17 as already known to the user 13.

It is to be understood that not all units, which are depicted in FIG. 1, are necessarily implemented or enabled in an interactive system according to the invention. For example, if an interactive system 1 is typically operated by a single user 13, like a mobile phone, the user identification unit 9 might not be present. Furthermore, not all aspects of a general interactive system 1 are illustrated in FIG. 1. For example, it is not shown, how an application 11, 11′, 11″ communicates with the user 13 while an application 11, 11′, 11″ is executed. Appropriate methods are known to those skilled in the art.

FIG. 2 illustrates a typical sequence of operations for introducing interaction pattern and/or functionalities according to the invention. In response to a user triggering in step A the execution of an application, the interactive system obtains in step B the characteristics of the interaction pattern and/or functionalities of that application. Furthermore, in step C, the interactive system identifies the user as described above and subsequently obtains in step D the interaction pattern and/or functionalities already known to the user. In the next step E, the interactive system compares the results of steps B and D, thereby obtaining the interaction pattern that are not known to the user. If all of them are known to the user, the interactive system continues (case G) with step K. Otherwise (case F), the interactive system obtains in step H the entry points for tutorial elements of unknown interaction pattern and invokes in step J the execution of the tutorial elements. Subsequently, the interactive system again compares in step K the results of steps B and D, thereby obtaining the functionalities not known to the user. If all of them are known to the user (case M), the interactive system immediately continues with the execution of the application in step P. Otherwise (case L), the interactive system obtains in step N the entry points for tutorial elements of unknown functionalities and invokes in step 0 the execution of the tutorial elements. Finally, the interactive system executes the application in step P.

All modules and units of the invention, with perhaps the exception of the user interface 2, could be realised in software using an appropriate processor. Although the present invention has been disclosed in the form of preferred embodiments and variations thereon, it will be understood that numerous additional modifications and variations could be made thereto without departing from the scope of the invention. For example, the selection of the tutorial elements might not only be based on previous introductions but also on data indicating to what extent a user is able to deal with new applications. Accordingly, if a user is very experienced, the interactive system might skip further introductions, even if some of the interaction pattern have not been introduced. Furthermore, separate storage units have been described. However, those storage units might be combined and implemented within in a shared memory means, like a computer hard drive that is used by a plurality of units.

For the sake of clarity, throughout this application, it is to be understood that the use of “a” or “an” does not exclude a plurality, and “comprising” does not exclude other steps or elements. The use of “unit” or “module” does not limit realisation to a single unit or module.

1. A method for introducing interaction pattern and/or functionalities of a plurality of applications (11, 11′, 11″) to the user (13) of an interactive system (1), wherein:
an application (11, 11′, 11″) provides characteristics (CR) of its interaction pattern and/or functionalities to the interactive system (1);
the interactive system (1) generates a selection (SE) of the interaction pattern and/or functionalities of an application (11, 11′, 11″) which are to be introduced to the user (13);
the interactive system (1) invokes the rendering of tutorial elements (6, 7, 14) to the user (13) to introduce the selected interaction pattern and/or functionalities.

2. The method according to claim 1, wherein the selection (SE) of interaction pattern and/or functionalities is deduced from records (8) of previous introductions of interaction pattern and/or functionalities.

3. The method according to claim 2, wherein the interactive system identifies a user and deduces the selection from records (8) of previous introductions of interaction pattern and/or functionalities invoked for the identified user (ID).

4. The method according to claim 1, wherein the tutorial elements (6) for introducing interaction pattern are stored in a memory means (18) of the interactive system (1).

5. The method according to claim 4, wherein tutorial elements (6) are adjusted to the functionalities of an application (11, 11′, 11″).

6. The method according to claim 1, wherein:
tutorial elements (7, 14) for introducing interaction pattern and/or functionalities are stored in a memory means (19) of an application (11, 11′, 11″);
an application (11, 11′, 11″) provides characteristics (CR) to the interactive system (1) enabling the interactive system (1) to invoke the rendering of the tutorial elements (7, 14).

7. The method according to claim 1, wherein the interactive system (1) invokes the rendering of tutorial elements (6, 7, 14) in response to an application (11, 11′, 11″) registering at the interactive system (1).

8. The method according to claim 1, wherein an application (11, 11′, 11″) provides characteristics (CR) of its interaction pattern with reference to the definition data (10) of interaction pattern supported by the interactive system (1).

9. An interactive system (1) supporting the execution of a plurality of applications (11, 11′, 11″), which is providing introductions of interaction pattern and/or functionalities of the applications (11, 11′, 11″) comprising:
a user interface (2);
a registration unit (3) for receiving the characteristics (CR) of the interaction pattern and/or functionalities provided by the applications (11, 11′, 11″);
a selection unit (4) for selecting which of the interaction pattern and/or functionalities are introduced to the user (13);
a tutorial unit (5) for invoking the rendering of tutorial elements (6, 7, 14) to the user (13) to introduce the selected interaction pattern and/or functionalities.

10. An interactive system (1) according to claim 9, comprising a speech based user interface.

11. A computer program product directly loadable into the memory of a programmable interactive system (1) comprising software code portions for performing the steps of a method according to claim 1 when said product is run on the interactive system (1).
